(19) United States
(12) Patent Application Publication
(10) Pub. No.: US 2019/0078662 A1
(43) Pub. Date: Mar. 14, 2019

(54) MULTI-STAGE TRANSMISSION FOR VEHICLES

(71) Applicants: Hyundai Motor Company, Seoul (KR); Kia Motors Corporation, Seoul (KR)

(72) Inventors: Seong Wook Ji, Gunpo-si (KR); Ki Tae KIM, lncheon (KR); Ju Hyeon PARK, Suwon-si (KR); Hyun Sik KWON, Seoul (KR); II Han YOO, Hwasun-eup (KR); Seong Wook HWANG, Gunpo-si (KR); Won Min CHO, Hwaseong-si (KR)

(73) Assignees: Hyundai Motor Company, Seoul (KR); Kia Motors Corporation, Seoul (KR)

(21) Appl. No.: 15/824,848

(22) Filed: Nov. 28, 2017

(30) Foreign Application Priority Data
Sep. 12, 2017 (KR) 10-2017-0116768

(51) Int. Cl. F16H 3/66

(52) U.S. Cl. CPC F16H 3/666; F16H 2200/203; F16H 2200/201

(57) ABSTRACT

A multi-stage transmission for vehicles may include an input shaft receiving power from an engine, an output shaft outputting the power, a first planetary gear set, a second planetary gear set, and a third planetary gear set, each of the planetary gear sets having three rotation elements, and seven rotation shafts connected to the rotation elements of the planetary gear sets.

### CROSS-REFERENCE TO RELATED APPLICATION

The present application claims priority to Korean Patent Application No. 10-2017-0116768, filed on Sep. 12, 2017, the entire contents of which is incorporated herein for all purposes by this reference.

### BACKGROUND OF THE INVENTION

### Field of the Invention

The present invention relates to a multi-stage transmission for vehicles, and more particularly to a multi-stage transmission for vehicles configured such that the maximum possible number of gear shift stages is realized through a relatively small number of parts and a simple structure, whereby the fuel economy of vehicles is improved.

### Description of Related Art

The recent increase in oil prices has forced vehicle manufacturers all around the world to improve the fuel economy of vehicles. In particular, extensive effort has been made to reduce the weight of engines through various technologies, such as downsizing, thereby improving the fuel economy of vehicles.

One of the fuel economy improvement methods that are applicable to a transmission provided in a vehicle is increasing the number of gear shift stages of the transmission such that the engine can be operated at a more efficient operation point, thereby ultimately improving fuel economy.

In the case in which the number of gear shift stages of the transmission is increased, the engine can be driven within relatively low revolutions per minute (RPM) range thereof, whereby the noise of the vehicle may be further attenuated.

As the number of gear shift stages of the transmission is increased, the number of parts forming the transmission is also increased, with the result that the ease of fitting the transmission in the vehicle is lowered, the costs and weight of the transmission are increased, and the transfer efficiency of the transmission is reduced. For these reasons, it is important to provide a transmission that exhibits maximum efficiency while having a small number of parts and a relatively simple structure in order to maximize the effect of improving fuel efficiency through the increase in the number of gear shift stages of the transmission.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a multi-stage transmission for vehicles configured such that the maximum possible number of gear shift stages is realized through a relatively small number of parts and a simple structure, whereby the fuel economy of vehicles is improved.

In accordance with various aspects of the present invention, the above and other objects can be accomplished by the provision of a multi-stage transmission for vehicles including an input shaft receiving power from an engine, an output shaft outputting the power, a first planetary gear set, a second planetary gear set, and a third planetary gear set, each of the planetary gear sets having three rotation elements, a first rotation shaft connected to a first rotation element of the first planetary gear set, a second rotation shaft connected to a second rotation element of the first planetary gear set and to the input shaft, a third rotation shaft connected to a third rotation element of the first planetary gear set and to a first rotation element of the third planetary gear set, a fourth rotation shaft connected to a first rotation element of the second planetary gear set, a fifth rotation shaft connected to a second rotation element of the second planetary gear set, a sixth rotation shaft connected to a third rotation element of the second planetary gear set, to a second rotation element of the third planetary gear set, and to the output shaft, and a seventh rotation shaft connected to a third rotation element of the third planetary gear set.

The multi-stage transmission may further include four clutches that interconnect the rotation shafts in respective pairs and two brakes that selectively connect one of the rotation shafts to which the input shaft or the output shaft is not connected to a transmission housing.

The four clutches may include a first clutch mounted between the second rotation shaft and the fourth rotation shaft, a second clutch mounted between the first rotation shaft and the fourth rotation shaft, a third clutch mounted between the third rotation shaft and the fifth rotation shaft, and a fourth clutch mounted between the fifth rotation shaft and the seventh rotation shaft, and the two brakes may include a first brake mounted between the first rotation shaft and the transmission housing and a second brake mounted between the seventh rotation shaft and the transmission housing.

The first, second and third rotation elements of the first planetary gear set may include a first sun gear, a first planet carrier, and a first ring gear, the first, second and third rotation elements of the second planetary gear set may include a second sun gear, a second planet carrier, and a second ring gear, and the first, second and third rotation elements of the third planetary gear set may include a third sun gear, a third planet carrier, and a third ring gear.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic view showing the structure of a multi-stage transmission for vehicles according to an exemplary embodiment of the present invention; and

FIG. 2 is a table showing operation modes of the multi-stage transmission for vehicles according to the exemplary embodiment of the present invention.

It may be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made more specifically to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the other hand, the invention(s) is/are intended to cover not only the exemplary embodiments, but also various alternatives, modifications, equivalents and other embodiments, which may be included within the spirit and scope of the invention as defined by the appended claims.

Hereinafter, exemplary embodiments of a multi-stage transmission for vehicles according to an exemplary embodiment of the present invention will be described with reference to the accompanying drawings.

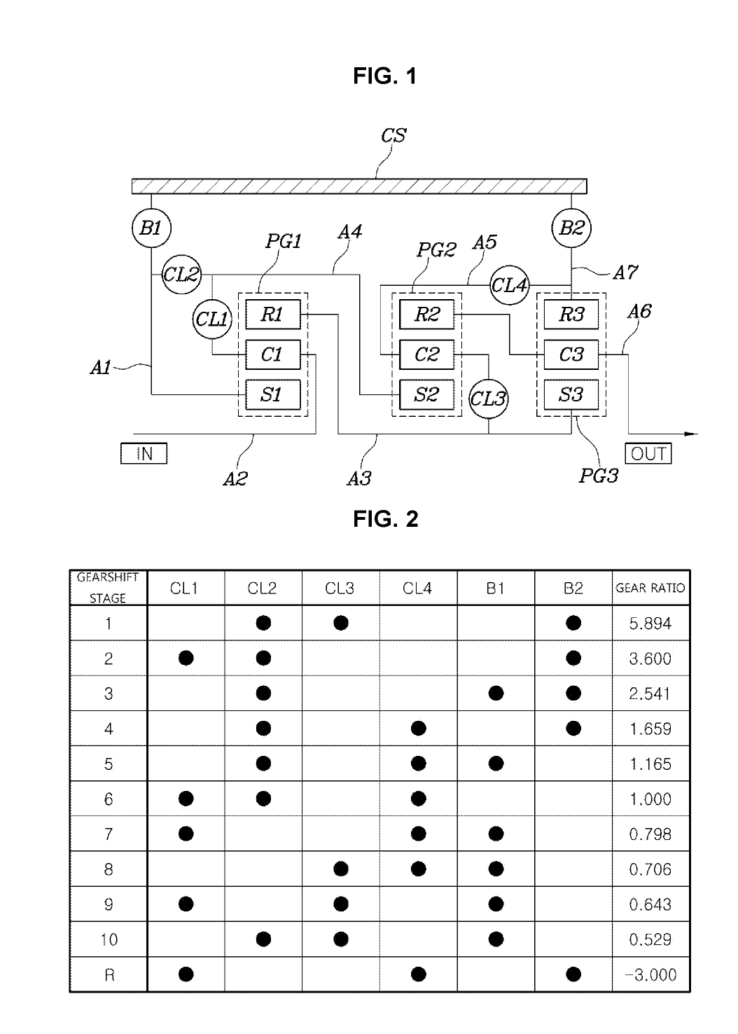

FIG. 1 is a schematic view showing the structure of a multi-stage transmission for vehicles according to an exemplary embodiment of the present invention. FIG. 2 is a table showing operation modes of the multi-stage transmission for vehicles according to the exemplary embodiment of the present invention.

Referring first to FIG. 1, the multi-stage transmission for vehicles according to an exemplary embodiment of the present invention includes an input shaft IN for receiving power from an engine, an output shaft OUT for outputting the power, a first planetary gear set PG1, a second planetary gear set PG2, and a third planetary gear set PG3, each of the planetary gear sets having three rotation elements, a first rotation shaft A1 connected to a first rotation element S1 of the first planetary gear set PG1, a second rotation shaft A2 connected to a second rotation element C1 of the first planetary gear set PG1 and to the input shaft IN, a third rotation shaft A3 connected to a third rotation element R1 of the first planetary gear set PG1 and to a first rotation element S3 of the third planetary gear set PG3, a fourth rotation shaft A4 connected to a first rotation element S2 of the second planetary gear set PG2, a fifth rotation shaft A5 connected to a second rotation element C2 of the second planetary gear set PG2, a sixth rotation shaft A6 connected to a third rotation element R2 of the second planetary gear set PG2, to a second rotation element C3 of the third planetary gear set PG3, and to the output shaft OUT, and a seventh rotation shaft A7 connected to a third rotation element R3 of the third planetary gear set PG3.

The first planetary gear set PG1, the second planetary gear set PG2, and the third planetary gear set PG3 may be sequentially disposed in the axial direction from the input shaft IN to the output shaft OUT.

Furthermore, the present invention is characterized in that the multi-stage transmission further includes four clutches that interconnect the rotation shafts in respective pairs and two brakes that selectively connect one of the rotation shafts to which the input shaft IN or the output shaft OUT is not connected to a transmission housing CS.

The four clutches include a first clutch CL1 mounted between the second rotation shaft A2 and the fourth rotation shaft A4, a second clutch CL2 mounted between the first rotation shaft A1 and the fourth rotation shaft A4, a third clutch CL3 mounted between the third rotation shaft A3 and the fifth rotation shaft A5, and a fourth clutch CL4 mounted between the fifth rotation shaft A5 and the seventh rotation shaft A7. The two brakes include a first brake B1 mounted between the first rotation shaft A1 and the transmission housing CS and a second brake B2 mounted between the seventh rotation shaft A7 and the transmission housing CS.

That is, the first brake B1 and the second brake B2 serve respectively to restrict or allow the rotation of the first rotation element S1 of the first planetary gear set PG1 and the third rotation element R3 of the third planetary gear set PG3.

The first, second and third rotation elements of the first planetary gear set PG1 include a first sun gear S1, a first planet carrier C1, and a first ring gear R1. The first, second and third rotation elements of the second planetary gear set PG2 include a second sun gear S2, a second planet carrier C2, and a second ring gear R2. The first, second and third rotation elements of the third planetary gear set PG3 include a third sun gear S3, a third planet carrier C3, and a third ring gear R3.

The multi-stage transmission including the three planetary gear sets and the six gear shifting elements as described above may realize 10 forward stages and 1 reverse stage according to the operation mode table shown in FIG. 2. A large number of gear shift stages may be realized through a relatively small number of parts and a simple structure, whereby the fuel economy and quietness of vehicles are improved.

As is apparent from the above description, in the multi-stage transmission for vehicles having the above structure, the speed and direction of the rotation elements of the three planetary gear sets are changed according to selective intermittent operation of the clutches and the brakes, whereby gear shifting is achieved. It is possible to realize 10 forward stages and 1 reverse stage through such gear shifting.

Consequently, it is possible to improve fuel economy by increasing the number of gear shift stages of an automatic transmission and to attenuate traveling noise of the vehicle by use of an operation point within a low RPM range of the engine.

For convenience in explanation and accurate definition in the appended claims, the terms “upper”, “lower”, “internal”, “outer”, “up”, “down”, “upper”, “lower”, “upwards”, “downwards”, “front”, “rear”, “back”, “inside”, “outside”, “inwardly”, “outwardly”, “internal”, “external”, “internal”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A transmission apparatus for a vehicle comprising:
an input shaft receiving power from an engine;
an output shaft outputting the power;
a first planetary gear set, a second planetary gear set, and a third planetary gear set, each of the planetary gear sets having three rotation elements including first, second, and third rotation elements;
a first rotation shaft fixedly connected to the first rotation element of the first planetary gear set;
a second rotation shaft fixedly connected to the second rotation element of the first planetary gear set and to the input shaft;
a third rotation shaft fixedly connected to the third rotation element of the first planetary gear set and to the first rotation element of the third planetary gear set;
a fourth rotation shaft fixedly connected to the first rotation element of the second planetary gear set;
a fifth rotation shaft fixedly connected to the second rotation element of the second planetary gear set;
a sixth rotation shaft fixedly connected to the third rotation element of the second planetary gear set, to the second rotation element of the third planetary gear set, and to the output shaft; and
a seventh rotation shaft fixedly connected to the third rotation element of the third planetary gear set.

2. The transmission apparatus according to claim 1, further including:
four clutches that interconnect the first to seventh rotation shafts in respective pairs; and
two brakes that selectively connect one of the first to seventh rotation shafts to which the input shaft or the output shaft is not connected, to a transmission housing.

3. The transmission apparatus according to claim 2, wherein
the four clutches include a first clutch mounted between the second rotation shaft and the fourth rotation shaft, a second clutch mounted between the first rotation shaft and the fourth rotation shaft, a third clutch mounted between the third rotation shaft and the fifth rotation shaft, and a fourth clutch mounted between the fifth rotation shaft and the seventh rotation shaft, and
the two brakes include a first brake mounted between the first rotation shaft and the transmission housing and a second brake mounted between the seventh rotation shaft and the transmission housing.

4. The transmission apparatus according to claim 1, wherein
the first rotation element, the second rotation element, and the third rotation element of the first planetary gear set include a first sun gear, a first planet carrier, and a first ring gear, respectively,
the first rotation element, the second rotation element, and the third rotation element of the second planetary gear set include a second sun gear, a second planet carrier, and a second ring gear, respectively, and
the first rotation element, the second rotation element, and the third rotation element of the third planetary gear set include a third sun gear, a third planet carrier, and a third ring gear, respectively, respectively.
